(19) United States
(12) Patent Application Publication
(10) Pub. No.: US 2020/0355299 A1
(43) Pub. Date: Nov. 12, 2020

(54) SUPPORT MEMBER, SUPPORT MEMBER-ATTACHED WIRE HARNESS, AND SUPPORT STRUCTURE OF WIRE HARNESS

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Tetsuya NISHIMURA, Mie (JP); Satoshi UJITA, Mie (JP); Shigeki IKEDA, Mie (JP); Daisuke EBATA, Mie (JP); Kenta ARAI, Mie (JP); Ryuta TAKAKURA, Mie (JP); Housei MIZUNO, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 16/762,382

(22) PCT Filed: Aug. 20, 2018
(86) PCT No.: PCT/JP2018/030629

§ 371 Date: May 7, 2020

(30) Foreign Application Priority Data
Nov. 17, 2017 (JP) 2017-221658

(51) Int. Cl. F16L 3/10

(52) U.S. Cl. CPC F16L 3/1075

(57) ABSTRACT

A support member includes a fitting part formed to be fitted to a rod-like member and a harness support part. The fitting part includes: a body part including a base part and a rotational part formed to be rotatably connected to the base part via a hinge, a state of which can be changed between a close state where the base part and the rotational part are fitted to the rod-like member and an open state where the rotational part rotates in a direction to be opened from the close state; and a rotational state changing part formed so that the state of the body part is changed from the open state to the close state upon receiving a pressing force from the rod-like member disposed in the body part in a state where the base part and the rotational part are in the open state.

### TECHNICAL FIELD

The present invention relates to a technique of making a rod-like member support a wire harness.

### BACKGROUND ART

Patent Document 1 discloses a technique of making a rod-like member support a wire harness. A wire harness support member described in Patent Document 1 includes a fitting part which the rod-like member can be held in and fitted to and a protection part provided to be integral with the fitting part on an outer periphery of the fitting part to cover the wire harness.

### PRIOR ART DOCUMENTS

### Patent Documents

Patent Document 1: Japanese Patent Application Laid-Open No. 2014-11837

### SUMMARY

### Problem to be Solved by the Invention

However, in a case where the support member described in Patent Document 1 is fitted to the rod-like member in a state where the wire harness is fixed to the support member, there is a possibility that the fitting part is bent in one point if the fitting part is spread wide. In the meanwhile, there is a possibility that a fitting point cannot be visually recognized easily if the fitting part is fitted without being spread wide. For these reasons, there may be a trouble in fitting the support member to the rod-like member.

Thus, an object of the present invention is to provide a technique capable of performing a work of fitting a support member included in a support member-attached wire harness to a rod-like member easily.

### Means to Solve the Problem

In order to solve the above problem, a support member according to a first aspect includes: a fitting part formed to be able to be fitted to an outer peripheral part of a rod-like member; and a harness support part formed to support a wire harness on an outer periphery side of the fitting part, wherein the fitting part includes: a body part including a base part and a rotational part formed to be rotatably connected to the base part via a hinge, a state of which can be changed between a close state where the base part and the rotational part are fitted to the outer peripheral part and an open state where the rotational part rotates in a direction to be opened from the close state; and a rotational state changing part formed so that the state of the body part is changed from the open state to the close state upon receiving a pressing force from the rod-like member disposed in the body part in a state where the base part and the rotational part are in the open state.

A support member according to a second aspect is the support member according to the first aspect, wherein the fitting part further includes a protrusion fitted into a hole part formed in the rod-like member in a state where the rod-like member is disposed in the body part.

A support member according to a third aspect is the support member according to the second aspect, wherein the protrusion is formed so as not to be able to come out of the hole part in a state of being fitted into the hole part.

A support member according to a fourth aspect is the support member according to any one of the first to third aspects, wherein the body part is formed to be able to cover a whole periphery of the outer peripheral part in the close state, and the fitting part further includes a locking hook and a locking eye part provided on one end side and another end side of the body part in a circumferential direction, respectively, and formed to be able to be mutually locked when the body part enters the close state.

A support member according to a fifth aspect is the support member according to any one of the first to fourth aspects, wherein the rotational part is provided to only one side of the base part in a circumferential direction in the body part.

A support member according to a sixth aspect is the support member according to any one of the first to fourth aspects, wherein the rotational part is provided to both sides of the base part in a circumferential direction in the body part.

A support member according to a seventh aspect is the support member according to any one of the first to sixth aspects, wherein the rotational state changing part includes a protruding piece protruding from the rotational part toward a housing space in the body part in the open state.

A support member according to an eighth aspect is the support member according to the seventh aspect, wherein a concave part through which the protruding piece can pass is formed in the base part.

A support member-attached wire harness according to a ninth aspect includes the supporting member according to any one of the first to eighth aspects and the wire harness supported by the support member using the harness support part.

A support structure of a wire harness according to a tenth aspect includes the support member-attached wire harness according to the ninth aspect and the rod-like member to which the fitting part of the support member in the support member-attached wire harness is fitted.

### Effects of the Invention

According to each aspect, the rotational part is provided, thus the body part can be widely opened to be in the open state, and the rod-like member can be easily disposed in the body part. The rotational state changing part is provided, thus even when the body part is in the open state, the state of the body part can transition to the close state by positioning the rod-like member in the body part. According to these configurations, an operation of fitting the support member to the rod-like member can be easily performed.

According to the second aspect, the protrusion is fitted into the hole part, thus the support member can be positioned on the rod-like member more reliably.

According to the third aspect, the protrusion is fitted into the hole part, thus the support member can also be positioned on the rod-like member.

According to the fourth aspect, the fitting state of the support member fitted to the rod-like member can be kept by the locking hook and the locking eye part.

According to the fifth aspect, a rotatable state can be simplified.

According to the sixth aspect, the body part can be widely opened.

According to the seventh aspect, when the rod-like member is disposed, the protruding piece located in the housing space is pressed by the rod-like member, thus the state of the body part is changed from the open state to the close state.

According to the eighth aspect, the concave part can be used for die cutting or for housing the protruding piece in the fitting state.

### BRIEF DESCRIPTION OF DRAWINGS

FIG. 1 A front view illustrating a support structure of a wire harness according to a first embodiment.

FIG. 2 A side view illustrating the support structure of the wire harness according to the first embodiment.

FIG. 3 A perspective view illustrating an open state of a support member according to the first embodiment.

FIG. 4 A front view illustrating the open state of the support member according to the first embodiment.

FIG. 5 A perspective view illustrating a close state of the support member according to the first embodiment.

FIG. 6 An explanation diagram illustrating the support member supporting the wire harness.

FIG. 7 An explanation diagram illustrating a support member-attached wire harness supported by a rod-like member.

FIG. 8 A front view illustrating a support structure of a wire harness according to a second embodiment.

FIG. 9 A front view illustrating an open state of a support member according to the second embodiment.

FIG. 10 A front view illustrating an open state of a support member according to a modification example.

FIG. 11 An explanation diagram illustrating a retaining structure of a protruding piece.

FIG. 12 A front view illustrating a support structure of a wire harness according to a modification example.

### DESCRIPTION OF EMBODIMENT(S)

### First Embodiment

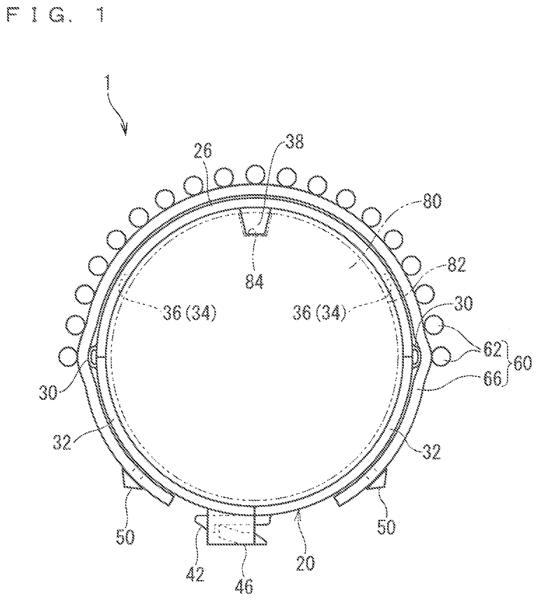

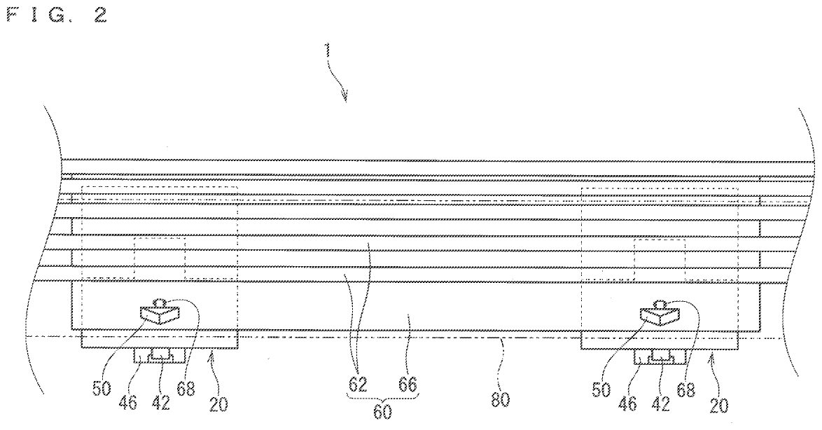

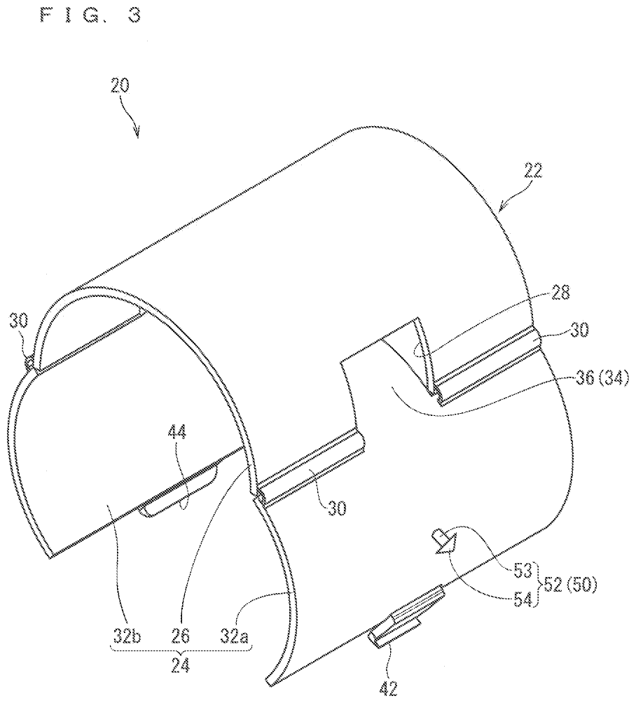

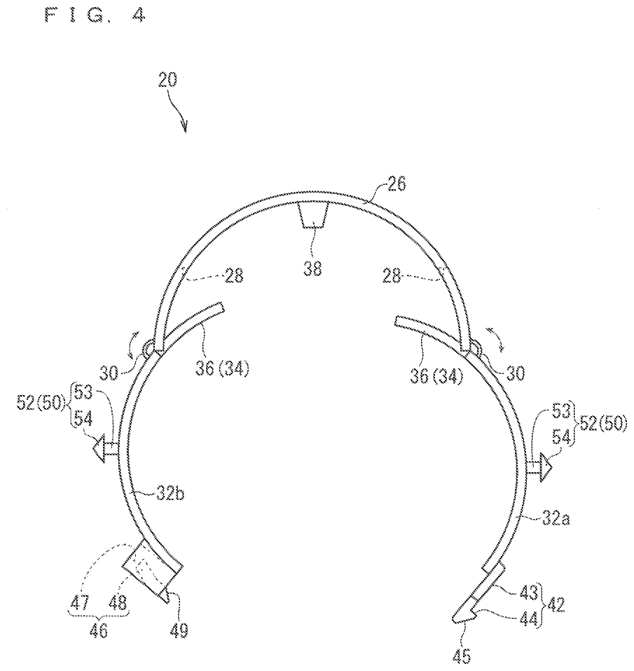

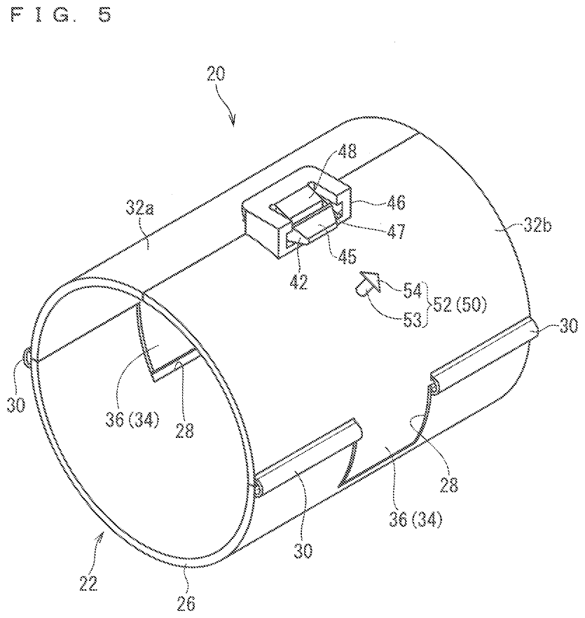

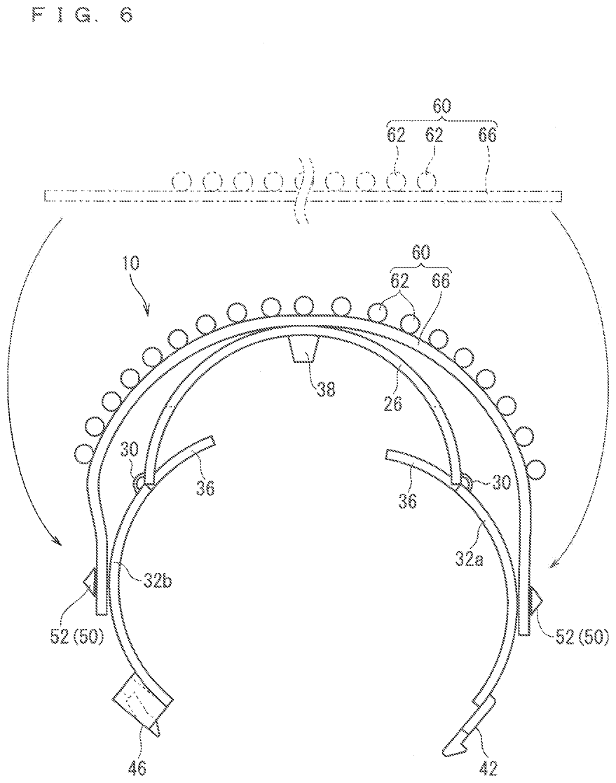

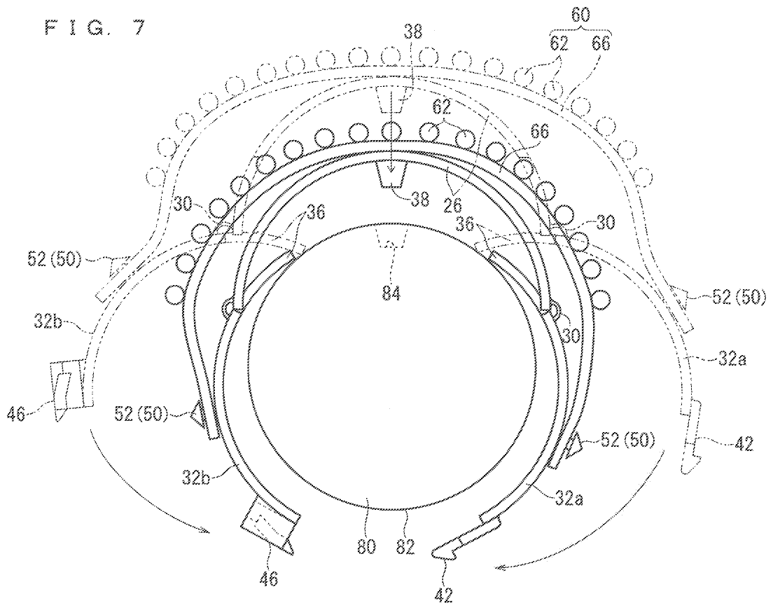

A support member, a support member-attached wire harness, and a support structure of the wire harness according to a first embodiment are described hereinafter. FIG. 1 is a front view illustrating a support structure 1 of the wire harness according to the first embodiment. FIG. 2 is a side view illustrating the support structure 1 of the wire harness according to the first embodiment. FIG. 3 is a perspective view of an open state of a support member 20 according to the first embodiment. FIG. 4 is a front view of the open state of the support member 20 according to the first embodiment. FIG. 5 is a perspective view of a close state of the support member 20 according to the first embodiment viewed from a direction different from that of FIG. 3. FIG. 6 is an explanation diagram illustrating the support member 20 supporting a wire harness 60. FIG. 7 is an explanation diagram illustrating a support member-attached wire harness 10 supported by a rod-like member 80.

The support structure 1 of the wire harness includes the support member-attached wire harness 10 and a rod-like member 80 supporting the support member-attached wire harness 10. The support member-attached wire harness 10 includes the support member 20 and the wire harness 60 supported by the support member 20. The support member 20 is fitted to the rod-like member 80, thereby the rod-like member 80 supports the support member 20. That is to say, in the support structure 1 of the wire harness, the wire harness 60 is supported by the rod-like member 80 via the support member 20.

The support member 20 is a member for making the rod-like member 80 support the wire harness 60. Specifically, the support member 20 includes a fitting part 22 and a harness support part 50. In the description herein, the support member 20 is an integrated molded component formed of a resin as a material.

The fitting part 22 is formed to be able to be fitted to an outer peripheral part 82 of the rod-like member 80. Specifically, the fitting part 22 includes a body part 24 and a rotational state changing part 34. The fitting part 22 further includes a protrusion 38, however, there may be a case where the fitting part 22 does not include the protrusion 38. In the similar manner, the fitting part 22 further includes a locking hook 42 and a locking eye part 46, however, there may e a case where the fitting part 22 does not include the locking hook 42 and the locking eye part 46.

The body part 24 is a part covering the outer peripheral part 82 of the rod-like member 80. Specifically, the body part 24 includes a base part 26 and a rotational part 32.

The base part 26 is formed to be able to cover part of the outer peripheral part 82 of the rod-like member 80. Herein, an inner peripheral part of the base part 26 is formed into a shape along the outer peripheral part 82 of the rod-like member 80. That is to say, a curvature radius of the inner peripheral part of the base part 26 is set to be the same degree as a curvature radius of the outer peripheral part 82 of the rod-like member 80. The base part 26 is formed to have a uniform thickness. Thus, the base part 26 is formed into a partial cylindrical shape in which a cross section has an arc-like shape.

The rotational part 32 is formed to be rotatably connected to the base part 26 via a hinge 30. The rotational part 32 is connected to an end portion of the base part 26 in a circumferential direction. The rotational part 32 covers part of the outer peripheral part 82 of the rod-like member 80 along the circumferential direction other than the part covered by the base part 26. Herein, the rotational part 32 is provided to both sides of the base part 26. Accordingly, the two rotational parts 32 are provided herein. In the description hereinafter, one of the two rotational parts 32 is referred to as a rotational part 32a and the other one thereof is referred to as a rotational part 32b as necessary. The rotational part 32 is formed into a partial cylindrical shape having the same curvature radius and thickness as the base part 26, for example.

A state of the body part 24 can be changed between a close state and an open state. Herein, the close state indicates a state where both the base part 26 and the rotational part 32 are located along the outer peripheral part 82 of the rod-like member 80, and indicates a state where the body part 24 is fitted to the outer peripheral part 82 of the rod-like member 80. The open state indicates a state where the rotational part 32 rotates in a direction to be opened from the close state, and indicates a state where the rotational part 32 extends to be separated from the outer peripheral part 82 of the rod-like member 80 when the base part 26 is located along the outer peripheral part 82 of the rod-like member 80.

Herein, the body part 24 is formed to be able to cover the whole periphery of the outer peripheral part 82 of the rod-like member 80 in the close state. When the body part 24 covers the whole periphery of the outer peripheral part 82 of the rod-like member 80, the base part 26 covers half the periphery of the outer peripheral part 82 of the rod-like member 80, and each of the rotational part 32a and the rotational part 32b covers a quarter of the periphery of the outer peripheral part 82 of the rod-like member 80 herein. However, a region where the base part 26, the rotational part 32a, and the rotational part 32b cover the outer peripheral part 82 of the rod-like member 80 is not limited thereto. The base part 26 may cover a larger region than half the periphery of the outer peripheral part 82 of the rod-like member 80, or may cover a smaller region. In the similar manner, each of the rotational parts 32a and 32b may cover a larger region than the quarter of the periphery of the outer peripheral part 82 of the rod-like member 80, or may cover a smaller region. Regions covered by the base part 26, the rotational part 32a, and the rotational part 32b may have the same size as each other. That is to say, each of the base part 26, the rotational part 32a, and the rotational part 32b may cover one-third the periphery of the outer peripheral part 82 of the rod-like member 80. Regions covered by the rotational part 32a and the rotational part 32b may have sizes different from each other. For example, it is also applicable that the rotational part 32a covers one-third the periphery of the outer peripheral part 82 of the rod-like member 80, whereas the rotational part 32b covers one-sixth the periphery of the outer peripheral part 82 of the rod-like member 80.

The rotational state changing part 34 is formed so that the state of the body part 24 is changed from the open state to the close state upon receiving a pressing force from the rod-like member 80 disposed in the body part 24 in a state where the base part 26 and the rotational part 32 are in the open state. The rotational state changing part 34 includes a protruding piece 36.

The protruding piece 36 is formed to protrude from the rotational part 32 toward a housing space in the body part 24 in the open state. Herein, the protruding piece 36 protrudes from an end surface of the rotational part 32 on a side of the base part 26. A dimension of the protruding piece 36 along an axial direction is set smaller than a dimension of the rotational part 32 along the axial direction. In this case, the protruding piece 36 protrudes from a middle part of the rotational part 32 in the axial direction. Accordingly, the rotational part 32 is connected to the base part 26 via the hinge 30 on both end sides in the axial direction. However, a position where the protruding piece 36 is formed is not limited thereto described above. For example, the protruding piece 36 may be formed from an inner peripheral part in the middle part of the rotational part 32 in the circumferential direction or an end surface of the rotational part 32 on an opposite side from an end surface on a side of the base part 26. For example, the protruding piece 36 may protrude from an end portion of the rotational part 32 in the axial direction.

A concave part 28 through which the protruding piece 36 can pass is formed in the base part 26. The concave part 28 is formed so that part of the end surface of the base part 26 facing part of the rotational part 32 connected to a base end portion of the protruding piece 36 is concaved in the circumferential direction. The protruding piece 36 and the concave part 28 are formed so that the concave part 28 is slightly larger than the protruding piece 36. Accordingly, the protruding piece 36 can be housed in the concave part 28 in the close state. There may be a case where the concave part 28 is used for passing a part corresponding to the protruding piece 36 in a mold at a time of forming the support member 20 by an extrusion molding, that is to say, as a hole for die cutting, for example.

The protrusion 38 is formed to be able to be fitted into a hole part 84 formed in the rod-like member 80 in a state where the rod-like member 80 is disposed in the body part 24. Herein, the protrusion 38 is formed to protrude from the inner peripheral part of the base part 26 into the housing space in the body part 24. The protrusion 38 is formed into a circular truncated cone shape. The protrusion 38 is fitted into the hole part 84 formed in the rod-like member 80, thus the support member 20 is positioned on the rod-like member 80. More specifically, the protrusion 38 is fitted into the hole part 84 formed in the rod-like member 80, thus suppressed is a rotation of the support member 20 around the rod-like member 80 in the circumferential direction or a deviation thereof in the axial direction.

Herein, the protrusion 38 is formed smaller than the hole part 84, and does not have a function of fixing the support member 20 to the rod-like member 80. That is to say, the protrusion 38 has only a function of positioning the support member 20 on the rod-like member 80 in the positioning function and the fixing function. However, there may also be a case where the protrusion 38 has the function of fixing the support member to the rod-like member 80 in addition to the positioning function. This case is described in detail in a second embodiment hereinafter.

The locking hook 42 and the locking eye part 46 are provided on one end side and the other end side of the body part 24 in the circumferential direction, respectively, and are formed to be able to be mutually locked when the body part 24 enters the close state, that is to say, in a state where the body part 24 covers the whole periphery of the outer peripheral part 82 of the rod-like member 80. Herein, the locking hook 42 is provided on a tip portion of the rotational part 32a, and the locking eye part 46 is provided on a tip portion of the rotational part 32b.

The locking hook 42 includes a hook body part 43 and a hooking piece 44 formed on a tip portion of the hook body part 43. An inclined surface 45 is formed in a position in the locking hook 42 closer to the tip portion than the hooking piece 44.

The locking eye part 46 includes an insertion part 47 through which the locking hook 42 can pass and a hooking piece 48 protruding in the insertion part 47 and hooked to the hooking piece 44 described above in a state where the locking hook 42 is inserted through the insertion part 47. When the locking hook 42 is inserted through the locking eye part 46, at least one of the locking hook 42 and the locking eye part 46 is elastically deformed, thus the hooking piece 44 is inserted into a position where the hooking piece 44 can be hooked to the hooking piece 48, for example. The locking eye part 46 includes a guide part 49 formed on an entrance of the insertion part 47 so as to be able to guide the locking hook 42 into the insertion part 47. The guide part 49 has an inclined structure similar to the inclined surface 45 of the locking hook 42. The inclined surface 45 of the locking book 42 has direct contact with the guide part 49 and slides along the guide part 49, thereby the locking hook 42 is guided into the insertion part 47.

The harness support part 50 is formed to support the wire harness 60 on an outer periphery side of the fitting part 22. Herein, a locking piece 52 is formed as the harness support part 50.

The locking piece 52 can be inserted into and locked to a through hole 68 formed in a sheet material 66 described hereinafter in the wire harness 60. The locking piece 52 includes a columnar part 53 protruding from the body part 24 and a wing part 54 protruding from a tip portion of the columnar part 53. The wing part 54 is formed to be gradually widened from a tip portion of the columnar part 53 toward a base end thereof, and a tip portion of the wing part 54 is set larger than the through hole 68. When the wing part 54 passes through the through hole 68, at least one of the wing part 54 and a peripheral edge part of the through hole 68 is elastically deformed, thus the wing part 54 can pass through the through hole 68. Then, after the wing part 54 passes through the through hole 68, the part which has been elastically deformed returns to an original shape, and the tip portion of the wing part 54 is hooked to the peripheral edge part of the through hole 68. Accordingly, the wire harness 60 is supported by the support member 20. Herein, the locking piece 52 is provided on the rotational part 32a and the rotational part 32b in the body part 24, however, also considered is that one or both of the two locking pieces 52 are provided on the base part 26. When the locking piece 52 is provided on the rotational part 32, the wire harness 60 can be disposed in a wider range on the support member 20. When the locking piece 52 is provided on the base part 26, a movement of the wire harness 60 in accordance with the opening of the rotational part 32 can be suppressed.

The wire harness 60 includes a plurality of electrical wires 62. The electrical wires 62 are insulated electrical wires each including a core wire and an insulating covering for covering the core wire. The plurality of electrical wires 62 are arranged along the outer peripheral part 82 of the rod-like member 80.

Herein, the wire harness 60 further includes the sheet material 66. The sheet material 66 is formed of a resin or metal, for example, as a material. The sheet material 66 can be bended and deformed to be in a flat state (a state of extending along a certain flat surface) and a state of being located along the outer peripheral part 82 of the rod-like member 80.

The plurality of electrical wires 62 are flattened using the sheet material 66. More specifically, the electrical wires 62 are disposed side by side on the sheet material 66. In this case, the electrical wires 62 are fixed to the sheet material 66 by sewing, bonding, or welding, for example. Accordingly, the electric wires 62 are kept to be flat. Then, the sheet material 66 is rolled along the outer peripheral part 82 of the rod-like member 80, thus the electrical wires 62 fixed side by side to the sheet material 66 are arranged side by side along the outer peripheral part 82 of the rod-like member 80.

The through hole 68 is formed in the sheet member 66. The locking piece 52 as the harness support part 50 is inserted into and locked to the through hole 68, thus as illustrated in FIG. 6, the wire harness 60 is supported by the support member 20. Accordingly, the support member-attached wire harness 10 is formed.

The rod-like member 80 is formed so that a cross section of the outer peripheral part 82 has a circular shape. Herein, the rod-like member 80 is formed into a full columnar shape. However, the cross section of the outer peripheral part 82 of the rod-like member 80 may be formed into a shape other than the circular shape such as an angular shape. The rod-like member 80 may have a tubular shape to internally have a space, for example. The rod-like member 80 is considered a reinforcement, for example. Particularly, the rod-like member 80 is considered a reinforcement disposed on a back side of an installment panel.

As described above, the hole part 84 into which the protrusion 38 formed in the support member 20 is fitted is formed in the rod-like member 80. The hole part 84 is formed into a shape corresponding to the protrusion 38. As described above, the hole part 84 is formed larger than the protrusion 38.

When the rod-like member 80 is made to support the support member-attached wire harness 10, a worker fits the support member 20 to the rod-like member 80 in a state where the support member 20 is in the open state, for example. Accordingly, the rod-like member 80 enters the housing space in the support member 20 from an opening between the rotational parts 32a and 32b, and has direct contact with a protruding piece 36 in due course as indicated by a virtual line in FIG. 7. When the base part 26 of the support member 20 is moved toward the rod-like member 80 as it is, the protruding piece 36 is pressed by the rod-like member 80 and the rotational part 32 rotates, and the state of the support member 20 is being changed to the close state as indicated by a solid line in FIG. 7. Herein, when the rod-like member 80 enters a predetermined position in the housing space in the support member 20, the state of the support member 20 is changed to the close state, and the protrusion 38 is fitted into the hole part 84. At this time, there may be a case where the locking hook 42 is automatically locked to the locking eye part 46 in accordance with the transition of the state of the support member 20 to the close state or a case where a worker helps the locking hook 42 to be locked to the locking eye part 46. In the manner described above, the support member-attached wire harness 10 is supported by the rod-like member 80, and the support structure 1 of the wire harness illustrated in FIG. 1 is formed.

According to the above embodiment, the rotational part 32 is provided on the support member 20, thus the body part 24 can be widely opened to be in the open state, and the rod-like member 80 can be easily disposed in the body part 24. The rotational state changing part 34 is provided on the support member 20, thus even when the body part 24 is in the open state, the state of the body part 24 can transition to the close state by positioning the rod-like member 80 in the body part 24. According to these configurations, an operation of fitting the support member 20 to the rod-like member 80 can be easily performed.

When the protrusion 38 is fitted into the hole part 84, thus the support member 20 can be positioned on the rod-like member 80 more reliably.

The fitting state of the support member 20 fitted to the rod-like member 80 can be kept by the locking book 42 and the locking eye part 46.

The rotational parts 32 are provided to the both sides of the base part 26 in the circumferential direction in the body part 24, thus the body part 24 can be widely opened.

When the rod-like member 80 is disposed, the protruding piece 36 located in the housing space is pressed by the rod-like member 80, thus the state of the body part 24 can be changed from the open state to the close state.

The concave part 28 can be used for die cutting or for housing the protruding piece 36 in the fitting state.

### Second Embodiment

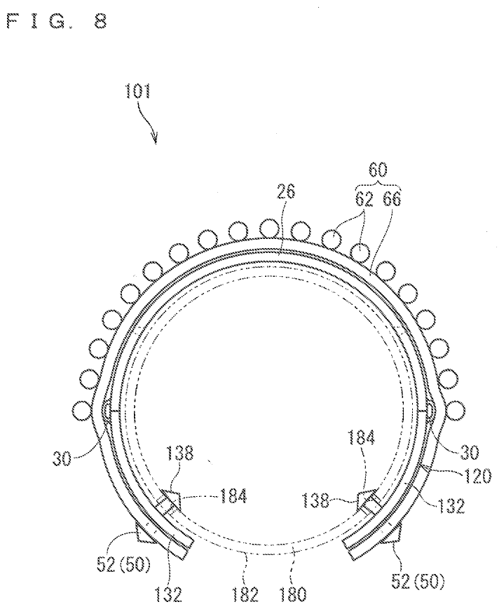

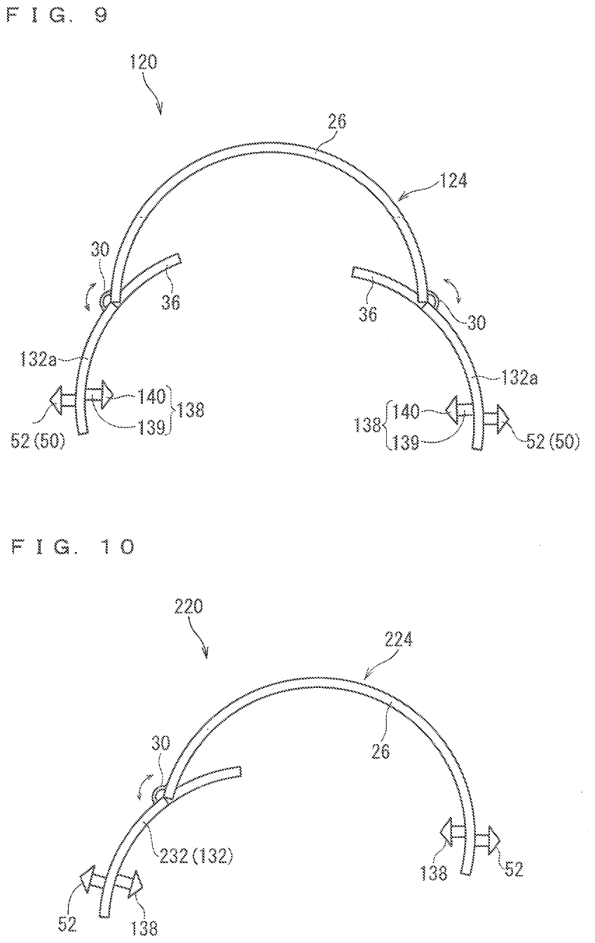

A support structure of a wire harness, a support member-attached wire harness, and a support member according to a second embodiment are described. FIG. 8 is a front view illustrating a support structure 101 of the wire harness according to the second embodiment. FIG. 9 is a front view illustrating an open state of a support member 120 according to the second embodiment. In the following description of the present embodiment, the same reference numerals are assigned to the similar constituent elements described above, and the description thereof will be omitted.

In the support structure 101 of the wire harness according to the present embodiment, a shape of the support member 120 and a shape of the rod-like member 180 are different from the shape of the support member 20 and the shape of the rod-like member 80 in the support structure 1 of the wire harness according to the first embodiment.

Specifically, in the support member 120, the body part 124 is formed to cover part of an outer peripheral part 182 of the rod-like member 180. Herein, the body part 124 is formed to cover a larger region than half the periphery of the outer peripheral part 182 of the rod-like member 180. In this case, the base part 26 covers half the periphery of the outer peripheral part 182 of the rod-like member 180, and each of rotational parts 132a and 132b covers a region smaller than a quarter of the periphery of the outer peripheral part 82 of the rod-like member 80 (one-sixth the periphery of the outer peripheral part 182 of the rod-like member 180).

However, there may be a case where the body part 124 is formed to cover half the periphery of the outer peripheral part 182 of the rod-like member 180, or formed to cover a region smaller than half the periphery of the outer peripheral part 182 of the rod-like member 180. Herein, also in the case where the body part 124 is formed to cover the part of the outer peripheral part 182 of the rod-like member 180 as is the case for the support member 120 according to the present embodiment, the region where the base part 26 and the rotational part 132 cover the outer peripheral part 182 of the rod-like member 180 is not limited thereto described above, but may be appropriately set in the manner similar to the support member 20 according to the first embodiment described above.

In the support member 120, the body part 124 does not cover the whole periphery of the outer peripheral part 182 of the rod-like member 180, thus the fixing structure using the locking hook 42 and the locking eye part 46 described above is hardly adopted. Accordingly, in the support member 120, a fixing structure using a protrusion 138 is adopted instead of the fixing structure using the locking hook 42 and the locking eye part 46 described above.

Specifically, the protrusion 138 is formed so as not to be able to come out of a hole part 184 in a state of being fitted into the hole part 184. In this case, the protrusion 138 is formed into a shape similar to that of the locking piece 52. That is to say, the protrusion 138 is formed into a shape including a columnar part 139 similar to the columnar part 53 and a wing part 140 similar to the wing part 54. The rod-like member 180 is formed into a tubular shape. The hole part 184 in the rod-like member 180 is formed into a through hole-like shape which the protrusion 138 can be inserted into and locked to. When the protrusion 138 is inserted into and locked to the hole part 184, the protrusion 138 is held by the hole part 184 in a state of not coming out of the hole part 184, thus the support member 120 is fixed to the rod-like member 180. Accordingly, the protrusion 138 herein has the function of positioning the support member 120 on the rod-like member 180 in the manner similar to the protrusion 38 described above, and further has the function of fixing the support member 120 to the rod-like member 180.

Herein, the configuration enabling the protrusion 138 not to come out of the hole part 184 in the state of being fitted into the hole part 184 is not limited to the configuration of the protrusion 138 having the shape of the locking piece and the hole part 184 having the shape of the through hole described above. For example, also considered is a configuration that each of the protrusion 138 and the hole part 184 is formed into the shape similar to that of each of the protrusion 38 and the hole part 84 according to the first embodiment, and the protrusion 138 is formed larger than the hole part 184 and can be pressed in the hole part 184.

The protrusions 138 are provided on one end portion and the other end portion of the body part 124 in the circumferential direction, respectively. Herein, the one end portion and the other end portion of the body part 124 in the circumferential direction constitute the rotational part 132a and the rotational part 132b, respectively, thus the protrusion 138 is provided on the rotational part 132a and the rotational part 132b. However, a position of the protrusion 138 is not limited to the position described above. In the manner similar to the protrusion 38 according to the first embodiment, the protrusion 138 may be provided near a central portion of the body part 124 in the circumferential direction (the base part 26). Also in the case where the protrusion 138 is provided on the base part 26, the protruding piece 36 has direct contact with the outer peripheral part 182 of the rod-like member 180 in the state where the support member 120 is fit to the rod-like member 180, thus the rotation in the direction in which the rotational part 132 opens can be regulated. However, when the protrusions 138 are provided on the rotational part 132a and the rotational part 132b, respectively, the rotational part 132 can be directly fixed to the rod-like member 180, thus the rotation in the direction in which the rotational part 132 opens can be regulated more reliably. Furthermore, when the protrusions 138 are provided on the one end portion and the other end portion of the body part 124 in the circumferential direction, respectively, the worker can visually recognize the protrusions 138 easily in the state where the body part 124 is in the open state, thus can easily grasp the position where the protrusions 138 are fitted.

According to the present embodiment, the protrusion 138 is fitted into the hole part 184, thus the support member 120 can be fixed to the rod-like member 180. The support member 120 does not cover the whole periphery of the rod-like member 180, thus the support member 120 can be downsized. The protrusions 138 are provided on the one end portion and the other end portion of the body part 124 in the circumferential direction, respectively, thus the worker can visually recognize the protrusions 138 easily in the state where the body part 124 is in the open state, and can easily grasp the position where the protrusions 138 are fitted.

### Modification Example

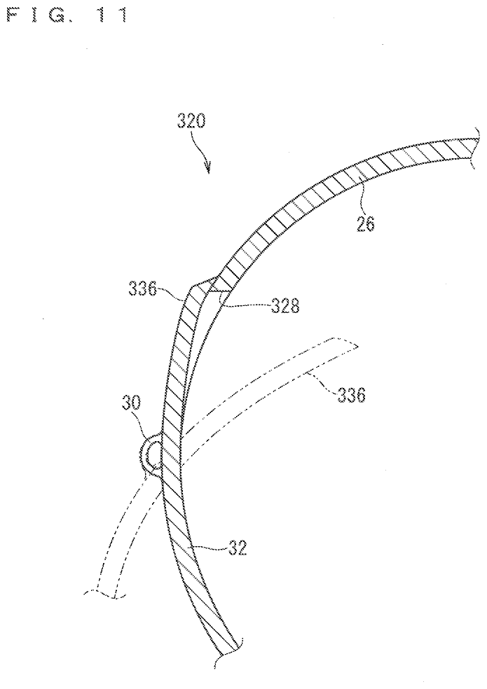

FIG. 10 is a front view illustrating an open state of a support member 120 according to a modification example.

In the above description, the rotational part 32 (132) are provided to the both sides of the base part 26 in the circumferential direction in the body part 24 (124), however, this configuration is not necessary. As illustrated in FIG. 10, also considered is that the rotational part 232 is provided to only one side of the base part 226 in the circumferential direction in the body part 224. In this case, the body part 224 may cover the whole periphery of the rod-like member 80, or may cover only part thereof.

For example, the body part 224 of the support member 220 illustrated in FIG. 10 has a shape similar to the body part 124 of the support member 120 according to the second embodiment except that one rotational part 132 is omitted. In this case, the locking piece 52 and the protrusion 138 formed on the omitted rotational part 132 are formed on the base part 26 instead of the rotational part 132.

According to the support member 220 having such a configuration, the rotational part 232 is provided to only one side of the base part 26 in the circumferential direction, thus the rotatable state can be simplified.

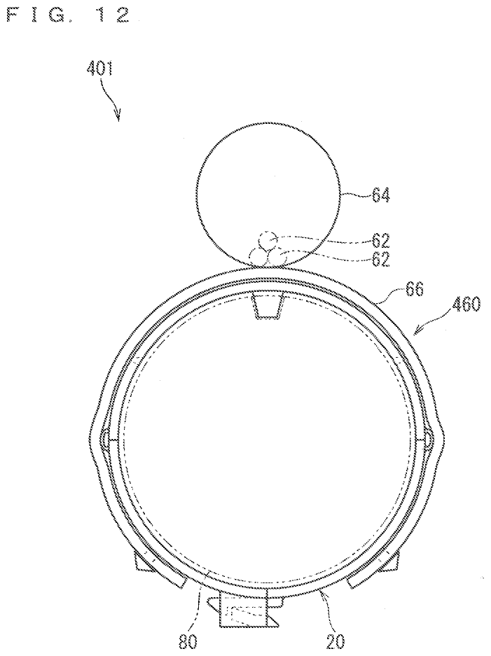

FIG. 11 is an explanation drawing illustrating a retaining structure of a protruding piece 336.

In the above description, the locking hook 42 is locked to the locking eye part 46 or the protrusion 138 cannot come out of the hole part 184 in the state of being fitted into the hole part 184, thus the rotational parts 32 and 132 are kept not to be rotatable in the support structures 1 and 101 of the wire harness, however, this configuration is not necessary. For example, as illustrated in FIG. 11, also considered is that the protruding piece 336 is formed to be able to pass through a concave part 328 and further can be hooked to a peripheral edge part of the concave part 328 in the state of passing through the concave part 328, thus the rotational part 332 is kept not to be rotatable.

In the example illustrated in FIG. 11, a length dimension of the protruding piece 336 (a dimension along the circumferential direction) is set larger than a length dimension of the concave part 328 (a dimension along the circumferential direction). The protruding piece 336 is formed to be able to bow. According to these configurations, the protruding piece 336 is formed to be able to pass through the concave part 328 and further can be hooked to the peripheral edge part of the concave part 328 in the state of passing through the concave part 328. As a result, the rotational part 32 is kept not to be rotatable in the state where the protruding piece 336 passes through the concave part 328. It is preferable that at least one of a tip portion of the protruding piece 336 and the peripheral edge part of the concave part 328 is formed into a shape of an inclined surface, for example, thereby serving as a guide part capable of bowing the protruding piece 336 when the tip portion of the protruding piece 336 and the peripheral edge part of the concave part 328 have direct contact with each other.

Also according to such a support member 320, the rotational part 32 can be kept not to be rotatable, thus a flutter of the rotational part 32 can be suppressed.

FIG. 12 is a front view illustrating a support structure 401 of a wire harness according to the modification example.

In the above description, the plurality of electrical wires 62 are disposed side by side along the circumferential direction on an outer periphery side of the support member 20, however, this configuration is not necessary. For example, as illustrated in FIG. 12, the plurality of electrical wires 62 in a wire harness 460 may be bound into an electrical wire bundle 64, thereby being collectively disposed. In this case, the plurality of electrical wires 62 are bound together in the example illustrated in FIG. 12, however, the plurality of electrical wires 62 may be divided into a plurality of sets and bound. That is to say, one electrical wire bundle 64 is disposed in the example illustrated in FIG. 12, however, the plurality of electrical wire bundles 64 may be disposed. The plurality of electrical wire bundles 64 may be disposed side by side along the circumferential direction on the outer periphery side of the support member 20.

In the above description, the locking piece 52 is provided as the harness support part 50, however, this configuration is not necessary. Also considered is that a holding part capable of holding the sheet material 66 is provided as the harness support part 50, for example. Considered as the holding part is a configuration that a cassette part supporting a connector connected to an end portion of the electrical wire 62 is provided on the support member 20 and the sheet material 66 is held between the connector supported by the cassette part and the support member 20, for example. Considered as the harness support part 50 is that a pouch part having a pouched shape is formed on the sheet material 66 and the end portion of the support member 20 is formed to be inserted into the pouch part, for example. In this case, the sheet material 66 is held between the support member 20 inserted into the pouch part and the rod-like member 80, thus the wire harness 60 can be supported. In this case, there may also be a case where these support structures and the structure of the locking piece 52 described above are adopted together in a support structure of one harness.

In the above description, the wire harness 60 includes the sheet material 66, however, this configuration is not necessary. There may also be a case where the wire harness 60 does not include the sheet material 66. Considered in this case is that the support member 20 is made to support the electrical wires 62 using a binding band used for binding the electrical wires 62, for example. More specifically, a holding part holding a band fixing part of the binding band and a fixing part capable of fixing the band in the manner similar to the band fixing part of the binding band are formed on the support member 20. At this time, it is preferable that the holding part is formed on one end portion of the base part 26 in the circumferential direction, and the fixing part is formed on the other end portion thereof. A band part of the binding band in which the band fixing part is held by the holding part is wound around an outer side of the electrical wires 62 in a state where the electrical wires 62 are located on the outer peripheral part 82 of the base part 26, and a tip portion of the band part is fixed to the fixing part.

The electrical wires can be supported by the support member 20 without using the sheet material 66 by a configuration that a fixing piece in which part of the body part 24 in the support member 20 in the circumferential direction extends in the axial direction is provided on the support member 20 and a tape or the like is wound around the fixing piece and the electrical wires 62, for example.

In the example illustrated in FIG. 2, the two support members 20 are provided with a predetermined distance along the axial direction of the rod-like member 80, and one sheet material 66 is supported by the two support members 20, however, this configuration is not necessary. There may also be a case where one sheet material 66 is supported by one support member 20 or supported by three or more support members 20.

In the example illustrated in FIG. 2, one end portions and the other end portions of all of the electrical wires 62 extend outside from one end portion and the other end portion of the sheet material 66, however, this configuration is not necessary. There may be a case where the end portions of the electrical wires 62 are located on the sheet material 66.

In the example illustrated in FIG. 2, all of the electrical wires 62 extend in parallel with the axial direction of the rod-like member 80 on the sheet material 66, however, this configuration is not necessary. At least one of the electrical wires 62 may extend in a direction different from that of at least the other one of the electrical wires 62 on the sheet material 66. Particularly, a branch may be formed on the sheet material 66. The electrical wires 62 may extend in a direction different from the axial direction of the rod-like member 80 such as the circumferential direction of the rod-like member 80, for example.

There may also be a case where the wire harness 60 includes the plurality of sheet materials 66 with a distance in a longitudinal direction of the electrical wires 62.

The protrusion 38 is formed on part of the body part 24 in the axial direction, however, this configuration is not necessary. There may also be a case where the protrusion 38 is formed to extend in the whole axial direction on the body part 24.

The configurations described in the embodiments and modification examples thereof can be appropriately combined as long as they are not contradictory.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

1 support structure of wire harness
10 support member-attached wire harness
20 support member
22 fitting part
24 body part
26 base part
28 concave part
30 hinge
32 rotational part
34 rotational state changing part
36 protruding piece
38 protrusion
42 locking hook
46 locking eye part
50 harness support part
52 locking piece
60 wire harness
62 electrical wire
66 sheet material
80 rod-like member

1. A support member, comprising:
a fitting part formed to be able to be fitted to an outer peripheral part of a rod-like member; and
a harness support part formed to support a wire harness on an outer periphery side of the fitting part, wherein
the fitting part includes:
a body part including a base part and a rotational part formed to be rotatably connected to the base part via a hinge, a state of which can be changed between a close state where the base part and the rotational part are fitted to the outer peripheral part and an open state where the rotational part rotates in a direction to be opened from the close state; and
a rotational state changing part formed so that the state of the body part is changed from the open state to the close state upon receiving a pressing force from the rod-like member disposed in the body part in a state where the base part and the rotational part are in the open state.

2. The support member according to claim 1, wherein
the fitting part further includes a protrusion fitted into a hole part formed in the rod-like member in a state where the rod-like member is disposed in the body part.

3. The support member according to claim 2, wherein
the protrusion is formed so as not to be able to come out of the hole part in a state of being fitted into the hole part.

4. The support member according to claim 1, wherein
the body part is formed to be able to cover a whole periphery of the outer peripheral part in the close state, and
the fitting part further includes a locking hook and a locking eye part provided on one end side and another end side of the body part in a circumferential direction, respectively, and formed to be able to be mutually locked when the body part enters the close state.

5. The support member according to claim 1, wherein
the rotational part is provided to only one side of the base part in a circumferential direction in the body part.

6. The support member according to claim 1, wherein
the rotational part is provided to both sides of the base part in a circumferential direction in the body part.

7. The support member according to claim 1, wherein
the rotational state changing part includes a protruding piece protruding from the rotational part toward a housing space in the body part in the open state.

8. The support member according to claim 7, wherein
A concave part through which the protruding piece can pass is formed in the base part.

9. A support member-attached wire harness, comprising:
the supporting member according to claim 1; and
the wire harness supported by the support member using the harness support part.

10. A support structure of a wire harness, comprising:
the support member-attached wire harness according to claim 9; and
the rod-like member to which the fitting part of the support member in the support member-attached wire harness is fitted.
